(19) United States
(12) Patent Application Publication
(10) Pub. No.: US 2006/0197302 A1
(43) Pub. Date: Sep. 7, 2006

(54) Two-speed manual wheelchair wheel

(75) Inventors: Stephen M. Meginniss III, Seattle, WA (US); SanFrancisco A. Sabin, Seattle, WA (US)

Correspondence Address: JENSEN + PUNTIGAM, P.S., SUITE 1020, 2033 6TH AVE, SEATTLE, WA, 98121, US

(73) Assignee: Magic Wheels, Inc., Seattle, WA (US)

(21) Appl. No.: 11/070,996

(22) Filed: Mar. 3, 2005

(51) Int. Cl. B62M 1/14

(52) U.S. Cl. 280/250.1

(57) ABSTRACT

A wheel for a manual wheelchair includes a gear assembly which is linked to the wheel and includes first and second gear ratio arrangements. A rotating shift mechanism provides the shift capability between the two gear ratios, the shift mechanism having two to six (preferably three) extended, approximately equally spaced leg members, mounted so as to rotate in a plane perpendicular to the axle between two positions. In one position of the shift assembly, the wheelchair is in a standard 1:1 gear ratio, while in another position, the wheelchair is in a lower, 2:1 gear ratio.

### GOVERNMENT RIGHTS

This invention was made with Government support under SBIR Grant No. 2 R44 HD357393 awarded by the U.S. Department of Health and Human Services, Public Health Service, National Institutes of Health. The Government has certain rights in the invention.

### TECHNICAL FIELD

This invention relates generally to wheels for manual wheelchairs, and more specifically concerns an improved two-speed manual wheelchair wheel.

### BACKGROUND OF THE INVENTION

Manual wheelchairs are preferred by many users over powered wheelchairs. Typically, manual wheelchairs are much lighter and easier to maneuver and to transport than power wheelchairs, as well as being significantly less expensive, both to purchase and maintain. Manual wheelchairs provide their users with a greater sense of independence than their powered counterparts. However, there are certain disadvantages for users of manual wheelchairs, including a significantly greater chance of injuries and/or discomfort, particularly after years of consistent use. These injuries include various acute and chronic arm and shoulder stress injuries/discomfort, as well as elbow, wrist and hand injuries/discomfort.

U.S. Pat. No. 6,805,371, owned by the assignee of the present invention, represented a substantial advance in the manual wheelchair art, providing a two-speed capability for manual wheelchairs, a conventional 1:1 mode and a lower, typically 2:1 mode, resulting in significant improvement in wheelchair maneuverability as well as ease and confidence in moving up inclines and down declines. Braking action was also significantly improved with the new wheel. The wheel also featured a quick-release capability so that wheels could be quickly and conveniently exchanged and/or replaced.

In the present invention, further improvements have been made to the '371 two-speed wheelchair wheel, including improvements to the shifting mechanism as well as the construction and configuration of the wheel itself, resulting in further improvement in ease and convenience of use and a lighter and more durable wheel structure.

### SUMMARY OF THE INVENTION

Accordingly, the present invention is a two-speed drive mechanism for a manual wheelchair, which comprises: a wheelchair wheel; a gear assembly which is linked to the wheel, the gear assembly including a first gear arrangement for driving a wheelchair with a first gear ratio and a second gear arrangement for driving a wheelchair with a second gear ratio; and a shift mechanism which is mounted for rotational action, between two positions, in a plane which is perpendicular to the wheel axle for shifting between first and second gear ratios, the shift mechanism including a plurality of leg members engageable by an operator to shift the gear assembly between the first and second gear ratios in the first rotational direction and to shift the gear assembly between the second and first gear ratios in the opposing rotational direction.

Another aspect of the invention is a wheel for a manual wheelchair, which comprises: a wheel adapted for use with manual wheelchairs, the wheel being solid in structural arrangement, with a flat outer region, an intermediate sloping region and a flat central region, with a depth between the outer region and the inner region in the range of ½ to 2 inches.

Another aspect of the invention is a wheel for a wheelchair, comprising: a wheel for use with a wheelchair; a hand rim, and a plurality of connecting elements for removably connecting the hand rim to the wheel, providing an easy replacement capability for the hand rim.

A further aspect of the invention is a two-speed manual wheelchair, which comprises: a wheelchair wheel, a gear assembly linked to the wheel which includes a first gear arrangement for driving a wheelchair in a first gear ratio and a second gear arrangement for driving a wheelchair in a second gear ratio; a shift mechanism mounted for rotation in a plane perpendicular to the wheel axle, to shift the gear mechanism between the first and second gear ratios; and a hub assembly which connects the wheel to the wheelchair, wherein the hub assembly includes a removable axle which fits into a receiving portion on the wheelchair, such that wheelchairs requiring different lengths of axles can be accommodated using the same wheelchair wheel.

### BRIEF DESCRIPTION OF THE DRAWINGS

FIG. 1 is a perspective view of the front (outboard) surface of the new wheelchair wheel.

FIG. 2 is an elevational view of the new wheel, showing the wheelchair wheel in place on a manual wheelchair.

FIG. 3 is a perspective view showing the rear (inboard) surface of the wheel.

FIG. 4 is an elevational view showing the wheel with the outer part of the shifting mechanism removed, with the gears shown in the lower gear ratio.

FIGS. 5A and 5B are an exploded view (5A) and a rear (inboard) view (5B) of the shifting mechanism in one gear ratio (1:1).

FIGS. 6A and 6B show the shift mechanism of FIGS. 5A and 5B in a second gear ratio (2:1).

FIG. 7 is a cross-sectional view showing the wheelchair wheel of the present invention with its hub assembly.

FIG. 8 is an exploded view showing the wheelchair wheel with an easily removable hand rim.

FIG. 9 is an exploded view showing an easily changeable axle feature of the wheelchair wheel.

### BEST MODE FOR CARRYING OUT THE INVENTION

U.S. Pat. No. 6,805,371, owned by the assignee of the present invention, discloses a two-speed wheelchair assembly for manual wheelchairs, using a hypocycloidal gear assembly. The contents of that patent are hereby incorporated by reference.

The wheelchair wheel shown and described herein also includes a hypocycloidal gear drive assembly, and further includes a convenient shifting mechanism between two gear ratios; specifically, a conventional 1:1 gear ratio and a lower gear ratio, in this embodiment a 2:1 gear ratio. It could be other gear ratios as well.

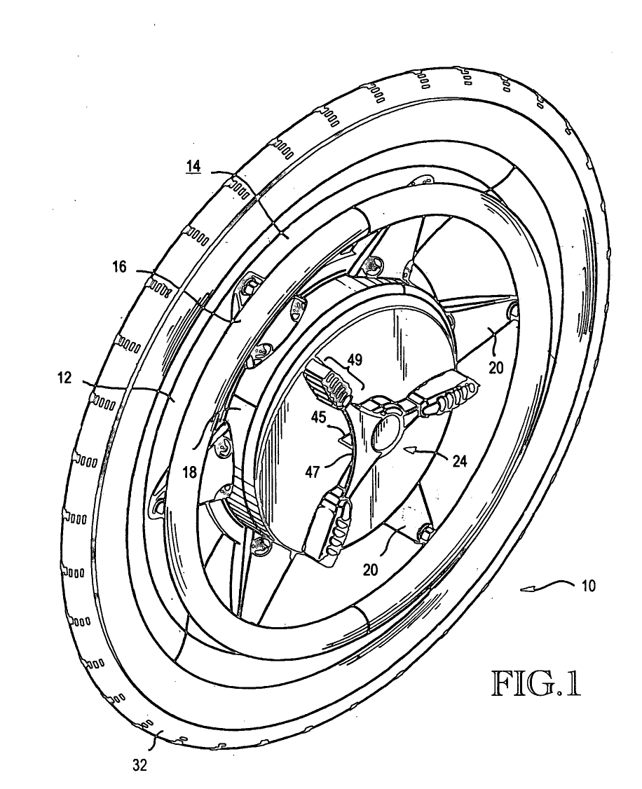

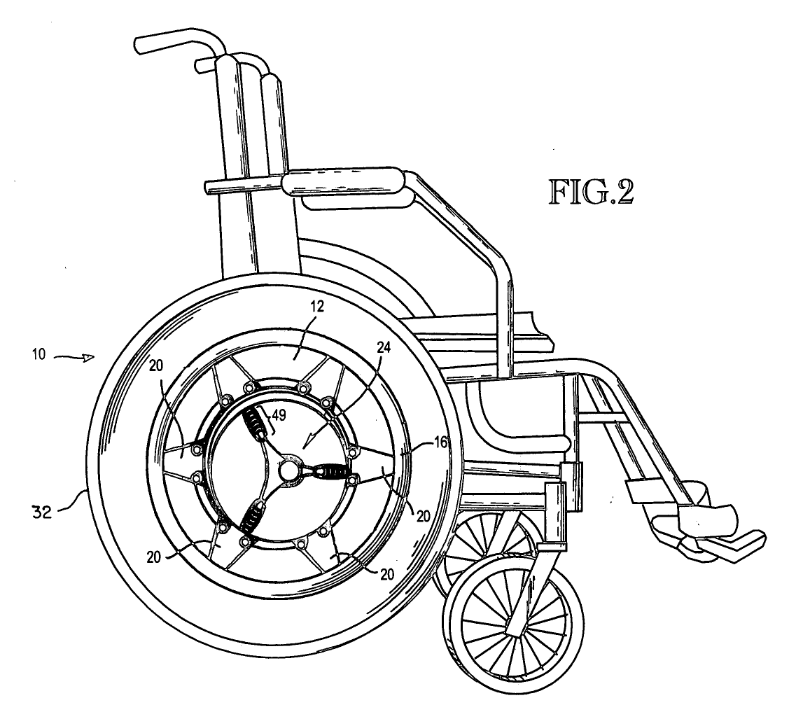

Referring now to FIGS. 1, 2 and 3, the new wheelchair wheel is shown generally at 10. Wheel 10 is solid, with a dish-shaped center region 12, as viewed from the outboard side of the wheel. The configuration and structure of the wheel itself will be explained in more detail below. The gear assembly for wheel 10 is enclosed in a housing 18. The gear assembly includes a hypocycloidal gearing arrangement which also is explained in more detail below, as well as in the '371 patent. A circular hand rim 16 is mounted to the wheel 10 by a series of rigid spokes or braces 20-20. A three-leg rotary shift mechanism, shown generally at 24, is also explained in more detail below.

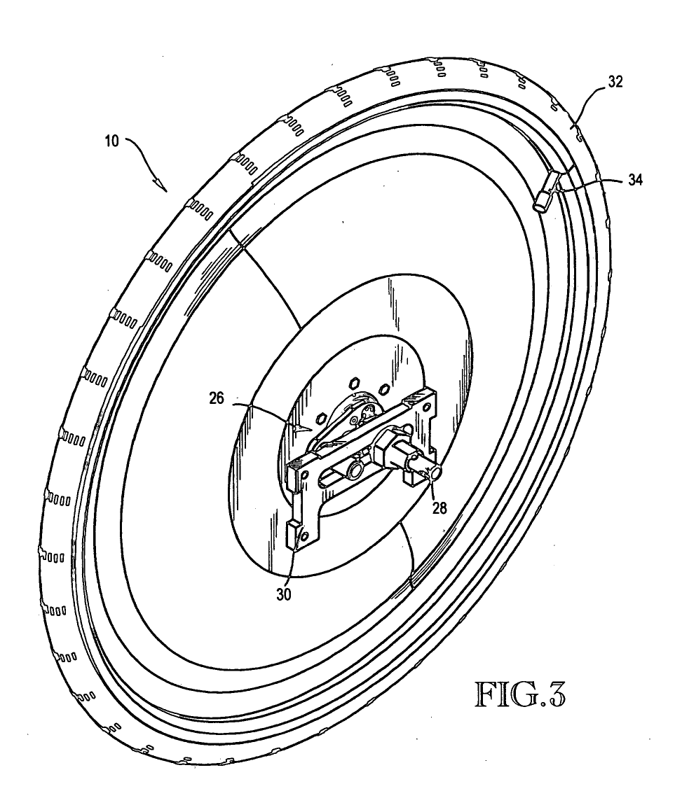

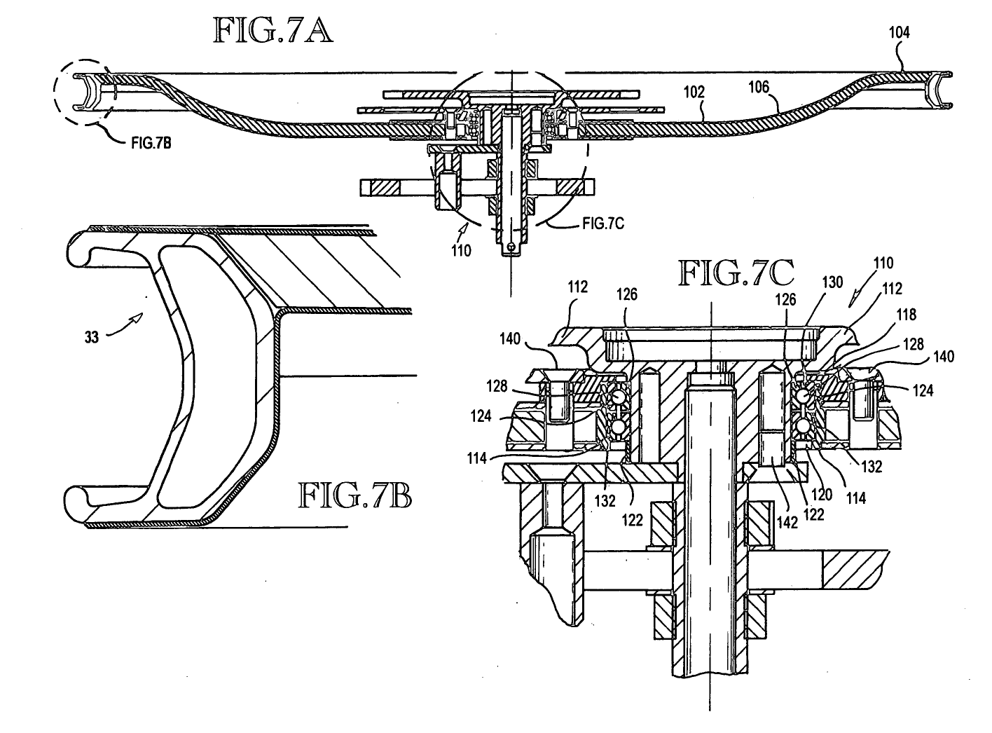

FIG. 3 shows the inboard side of wheel 10, including an axle hub assembly 26, which includes an axle member 28. Wheel 10 is readily connectable to and disconnectable from the wheelchair by a brace plate element 30 mounted on the wheelchair itself. This axle assembly/brace plate structure, including the quick-disconnect capability of axle 28 relative to the wheelchair, is shown and explained in detail in the '371 patent and therefore is not repeated here. The wheel 10 includes a tire 32 mounted on a peripheral rim surface 33 (shown in detail in FIG. 7), the tire being inflated through a valve element 34.

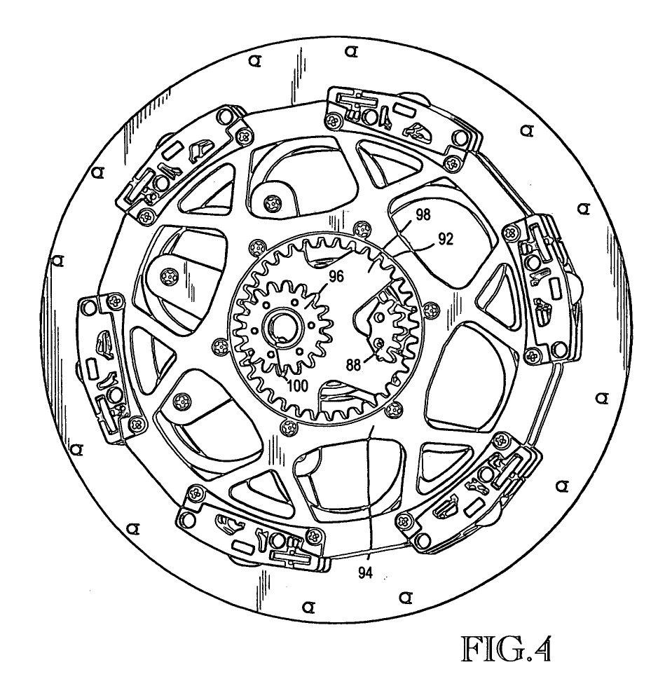

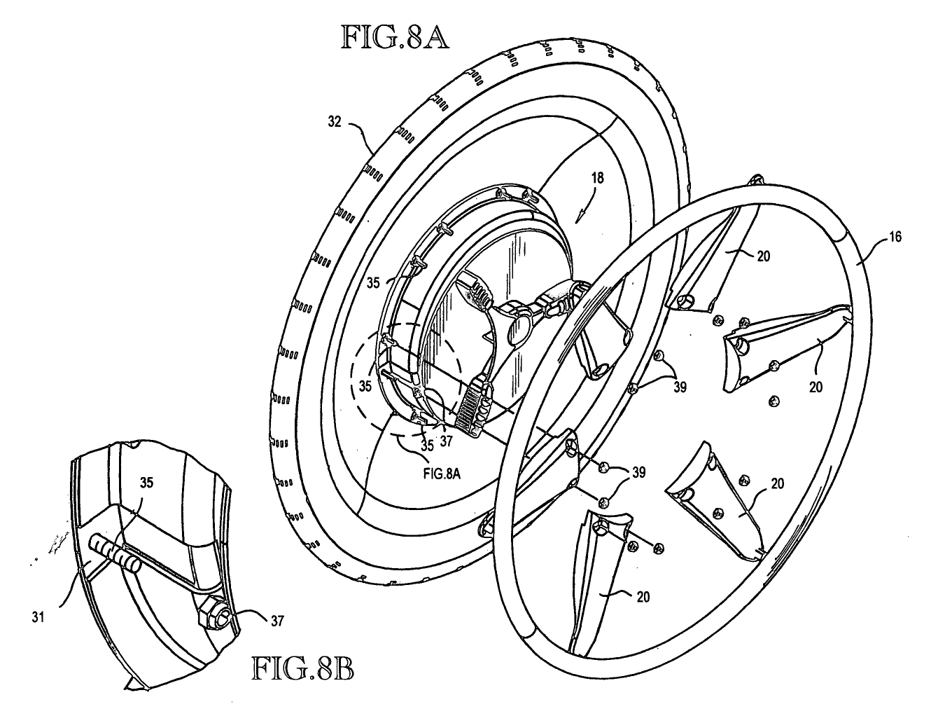

FIGS. 4, 5A, 5B, 6A and 6B show the shift mechanism of wheel 10. The shift mechanism 24, except for the three-legged shift handle and the shift plate on which it is mounted, is enclosed by housing 18, as is the gear assembly. Housing 18 is affixed to a circular metal band 31 (FIG. 8) positioned adjacent to, but not connected to the wheel, by means of a plurality of threaded studs 35-35, which extend from the metal band, and nuts 37-37. Spokes 20 also are connected to housing 18, by studs 35-35 and nuts 39-39.

The shift mechanism 24 includes a flat plate 42 and the three-legged shift handle 44 mounted thereon, each leg being separated by approximately 120° in the embodiment shown. The shift handle 44 should include at least two legs, but no more than six, generally equally spaced, to achieve the desired shifting results. Three legs are preferred. In the embodiment shown, shift handle 44 is made from plastic. Each leg 46 at the free end thereof includes a finger control portion 48, with each finger control portion including a series of ribs (non-smooth portions) 49 arranged therealong, on opposing sides thereof, to provide a gripping surface for the fingers of the user for convenient turning of the shift handle. Also, the center portion of shift handle 44 includes openings 45, 47 for two fingers, up to the first digit. The end of the openings is at the true center of the wheel. This arrangement is handy for convenient removal of the wheel from the wheelchair.

Mounted to the top surface of housing 18 (beneath plate 42) is a cutout guide plate member 50, also referred to as a shift guide plate. Guide plate member 50 includes two slightly curved extending portions 52 and 54 and two slots 56 and 58, wherein the lower edge of each slot is close to the bottom edge of the cutout plate 50. One of the legs on the shift handle has a cam follower member 62, which extends down into one of the slots 56 or 58 and rides in that slot from end to end thereof as shift handle 44 is rotated through an angle of approximately 24°, resulting in a movement of cam follower 62 of about 1 to 1-½ inches. In this arrangement, the slot acts as a cam. In an alternative arrangement, the slot (cam) could be in the shift handle and the cam follower on the shift guide plate.

The shift handle 44 is mounted so that its axis 66 moves through an arc of approximately 16° as the handle is moved, i.e. axis 66 does not remain fixed in space but rather moves through said arc. Axis 66 is slightly removed from the center of shift handle 44. The shift mechanism 24 includes a pushbutton element 68 which has an extending shaft 70. Circular plate 74 is mounted by a snap ring 79 into the top portion of housing 18. Mounted into circular plate 74 by a set of fasteners, such as screws, is a connecting element 78 which includes a shaft portion which extends beyond the rear surface 76 of circular plate 74 approximately ½ inch. Shaft 70 of the pushbutton element 68 extends through the center of shaft portion of connecting element 78. Shaft 70 includes end snap portions which prevent shaft 70 from coming back out from the connecting element shaft. Mounted on the connecting element shaft portion is a spur gear 96, which has a bearing element 100. When shift handle 44 is rotated and moves through its arcuate path, circular plate 74 and connecting element 78 rotate through an arc as well, moving spur gear 96 with them.

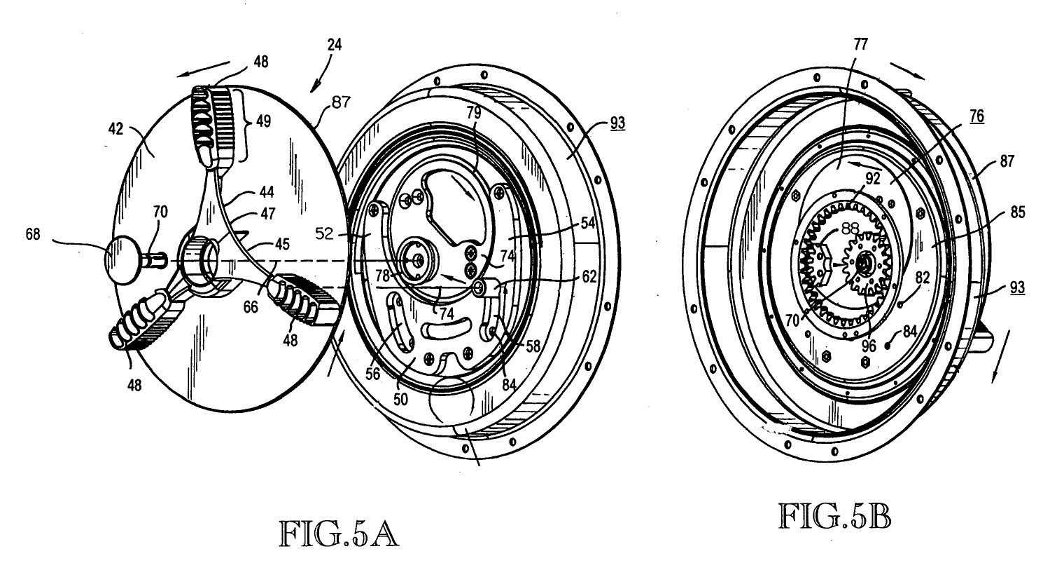

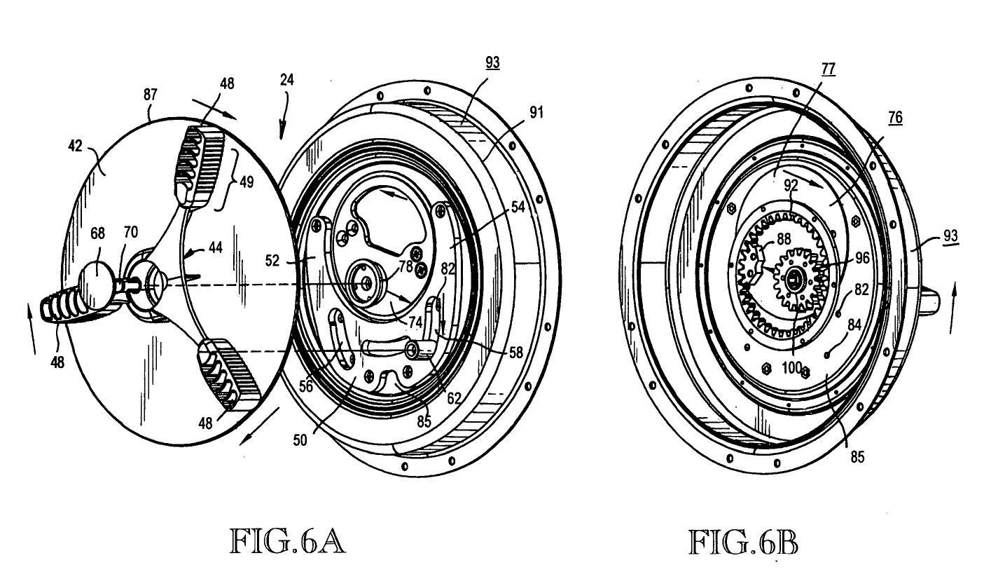

In the lower surface of cam follower element 62 is a small ball plunger member (not shown). The ball extends alternately into holes (detents) 82 and 84 in the top portion 85 of the housing as the cam follower element moves from end to end of the slot (slot 58 in FIGS. 5A, 5B and 6A, 6B) in which it is located.

Plate 42 of the shift mechanism is configured (circular) and mounted such that as shift handle 44 is rotated, plate 42 rotates such that a portion of its peripheral edge 87 extends beyond the peripheral edge surface 93 of housing 18. When the shift mechanism is in one position, i.e. when the wheel is in one gear ratio, the peripheral edge 87 of plate 42 is within the boundary of peripheral edge 93 of the housing, as shown in FIG. 6B. However, when the shift mechanism is moved to its other position, a portion of the edge 87 of plate 42 moves beyond the edge of the housing, as shown in FIG. 5B. This special relationship between the edge 87 of plate 42 relative to the edge surface 93 of housing 18 provides a tactile indication to the user of what gear the wheelchair is in.

Affixed to the rear (inboard) surface 76 of circular plate 74 is a gear sector 88. In the embodiment shown, gear sector 88 covers an arc of about 120°. Circular plate 74 rotates through an arc as described above, as the three-legged shift handle is rotated by the user.

A ring gear 92 is part of the gear assembly (FIG. 4). Ring gear 92 is fixed in position within the gear assembly by cage member 94. Spur gear 96 is mounted to the hypocycloidal gear assembly 98. Both gear sector 88 and spur gear 96 are adapted to mate with and turn ring gear 92 when they are separately engaged therewith. Turning of the ring gear 92, since it is part of cage member 94, which in turn is fixed to the wheel 10, will produce a turning of the wheel.

When gear sector 88 is engaged with ring gear 92 (shift handle 44 is in one position), the wheelchair is in a conventional 1:1 gear ratio. When shift handle 44 is moved to its other position, circular plate 74 is moved sufficiently to move gear sector 88, which is secured to the rear surface 76 of circular plate 74, out of engagement with ring gear 92 and moves spin gear 96 which is mounted on bearing member 100 into engagement with ring gear 92. In this position, the wheelchair is in a 2:1 gear ratio. The spin gear 96 is part of, as indicated above, a hypocycloidal gear assembly which produces the 2:1 gear action. This is shown and explained in more detail in the '371 patent, and hence is not explained in detail herein.

The shift handle 44 is convenient to move between its two positions. Cam follower member 62 in the embodiment shown moves a distance within a range of ¼-inch to 1-½ inches (one inch is preferred) in its associated slot in shifter guide plate 50 such that the ball is moved between the two holes 82 and 84. The use of the ball/detent arrangement is advantageous, since it provides a definite stop action for each of the two gear positions, providing to the user a definitive “feel” for each operative position of the shift handle, and also helps to keep the shift handle in gear during vibration of the wheelchair or back/forward movement of the wheel.

In order to facilitate ease of shifting, the gear teeth of ring gear 92, the gear sector 88 and the spur gear 96 are all rounded to some extent to help the engaging and disengaging of the two gears (gear sector 88 and spur gear 96) with the ring gear. Further to facilitate shifting, the rotational movement of the three-legged shift handle in an arcuate path, as opposed to a rotation about a fixed axis, results in a slight movement of the entire housing 18 (and the gear assembly) during the shift action. This makes possible a fast and easy one-handed shifting process between the 1:1 conventional ratio and the 2:1 lower gear ratio, in both directions, reducing the tendency of the gear assembly to hang up. The housing must rotate in the same direction as the shift handle to facilitate single-handed shift action.

FIG. 7 shows a cross-section of wheel 10, including the hub portion thereof, but without the gear assembly. Wheel 10 is useful as a wheelchair wheel with or without the gear assembly described above. The wheel is, as indicated above, a solid composite disc, such as carbon fiber or other high strength filament or fabric with foam. It is relatively thin, with a foam interior, approximately ¼-inch thick. The use of the relatively thin composite material has advantages of flexibility, an increase in shock absorption capability and the capability of rebounding to its original shape after it has been buckled due to extreme forces placed thereon.

It is “dish-shaped” in the inboard direction, with a flat center region 102 which is approximately ½-2 inches deep (1-½ inches is preferred) relative to the outer peripheral region 104. Outer peripheral region 104 in the embodiment shown will vary in width with the size of the tire and is flat. In one embodiment, this width could be approximately 2-⅛ inches. From this point toward the center of the wheel, the surface gradually curves or slopes smoothly inwardly for a width of approximately five inches. This portion is referred to at 106. From the end of region 106 to the hub of the wheel is the center region 102. The width of this region is approximately 5-½ inches on the radius.

FIG. 7 also shows the hub assembly 110 for the wheel. Hub assembly 110 includes an inner hub member 112 and an outer hub member 114. The hub assembly also includes a bearing structure which includes two bearings 118 and 120, positioned side by side and held in place by inner hub member 112, outer hub member 114 and a spacer 122. Each bearing 118, 120 includes an outer race 124, an inner race 126 and a set of ball bearings 128 which separate the two races, so that the inner race is free to rotate relative to the outer race. A flexible seal 130 between the two races seals the bearing, keeping dirt out and grease in the bearing.

A shim 132, with a width on the order of 0.008 inch, is positioned in the embodiment shown between the two outer races 124, 124 of the two adjacent bearings. The width of the shim could differ, depending on the particular bearing. There is no shim, however, between the two inner races, i.e. there remains a small space between the two adjacent inner races. The outer races 124, 124 are clamped together tightly by means of a plurality of fasteners 140-140, such as screws, around the periphery of the hub, two of which are shown in FIG. 7. When the fasteners 140 are tightened, the outer races are clamped together against the shim. The two inner races are clamped together (touching) by an inner set of fasteners 142, such as screws, one of which is shown in FIG. 7. This arrangement, with a shim between the two outer races but no shim between the two inner races, results in a stable, no-wobble (no play) bearing arrangement for the wheel. It should be understood that the shim could be located between the inner races, with no shim between the outer races.

FIG. 8 shows in more detail the easy remove feature of the hand rim 16 relative to the wheel 10. As indicated above, spokes (braces) 20-20, in this case six spokes, extend between hand rim 16 and the inner band 31, which is connected to the gear assembly housing 18. As indicated above, threaded studs 35-35 extend from band 31, to which housing 18 is connected. Nuts 37-37 capture housing 18 to the metal band 31 on studs 37-37, while nuts 39-39 then secure the spokes to the studs. Removal of nuts 39-39 permits quick and convenient removal of the hand rim, so that it can be replaced, if desired, by another hand rim of different size or configuration. This permits the user to have two or more hand rims, such as one for everyday use and one for sport use. In the embodiment shown in FIG. 1, hand rim 16 is 1-inch diameter tubing that may have a flattened outer side to enhance hand comfort. Other sizes of hand rims are possible. Further, the tubing can have a wavy, wrinkled or textured surface on the interior side of the tubing to provide a better gripping surface for the user.

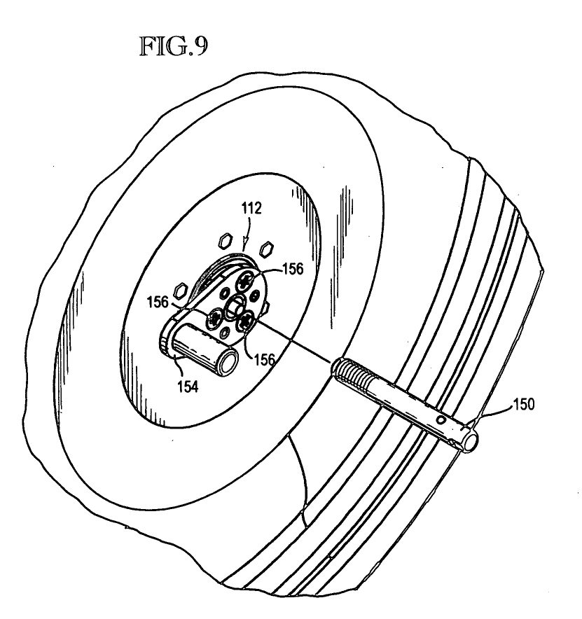

FIG. 9 shows another feature of the present invention, specifically an easy-removal axle 150. Axles can be of different axle lengths, depending upon the particular brand of wheelchair. In this arrangement, axle 150 is screwed into inner hub 112 (FIG. 7). Axle 150 can be readily unscrewed and replaced with an axle of a length which matches the requirements of the particular wheelchair being used. Hence, the present wheel can be conveniently used with a wide variety of wheelchairs. Also, the anti-rotation axle plate 154 may also be easily removed/replaced by removal of fasteners (screws) 156.

The wheelchair wheel shown in FIG. 1, for instance, has an advantage in that hand rim 16 can be positioned by the spokes relative to the sloped surface portion of the wheel (such as shown at 106 in FIG. 7) such that the overall width of the wheel, including the hand rim, can be maintained relatively small, while still providing adequate clearance for the hand/fingers between the hand rim and the smooth surface of the wheel. The solid, smooth surface and dished configuration prevents catching of the fingers during movement of the wheelchair. The dished configuration of the wheel provides a further advantage, in that it permits the mounting of a gear assembly within the dished portion, thus maintaining the overall width of the wheel approximately the same as a conventional wheelchair wheel.

Accordingly, various improvements to a two-speed wheelchair wheel for use with manual wheelchairs have been disclosed, including specifically improvements to the wheel itself, which has advantages as a wheelchair wheel without the gear assembly, as well as improvements in the gearing assembly and the shift mechanism which permits more convenient shifting with improved reliability and single-hand ease.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. A two-speed drive mechanism for a manual wheelchair, comprising:
a wheelchair wheel;
a gear assembly linked to the wheel, which includes a first gear arrangement for driving the wheelchair with a first gear ratio and a second gear arrangement for driving the wheelchair with a second gear ratio; and
a shift mechanism mounted for rotational action, between two positions, in a plane perpendicular to the wheel axle for shifting between the first and second gear ratios, the shift mechanism including a plurality of leg members engageable by an operator to shift the gear assembly between the first and second gear ratios in a first rotational direction and to shift the gear assembly between the second and first gear ratios in the opposing rotational direction.

2. The drive mechanism of claim 1, wherein the shift mechanism includes two to six leg members.

3. The drive mechanism of claim 1, wherein the shift mechanism includes three approximately equally spaced leg members.

4. The drive mechanism of claim 1, including two openings in a center portion of the shift mechanism, large enough to accommodate the first digits of two fingers.

5. The drive mechanism of claim 1, wherein the first gear ratio is 1:1 and the second gear ratio is 2:1.

6. The drive mechanism of claim 1, including a shift guide plate with a cam element therein, mounted on a top portion of a housing for the gear assembly, wherein the shift mechanism is movable relative to the shift guide plate and includes a cam follower element which extends into the cam element and moves therealong as the shift mechanism is rotated in one direction or the other.

7. The drive mechanism of claim 6, wherein the cam element is a slot.

8. The drive mechanism of claim 1, including a shaft guide plate with a cam follower element, mounted on a top portion of a housing for the gear assembly, wherein the shift mechanism is movable relative to the shift guide plate and includes a cam element therein which receives the cam follower element, which moves along the cam element as the shift mechanism is rotated in one direction or the other.

9. The drive mechanism of claim 5, wherein the shift mechanism has a shift axis shaft, which moves along an arc as the legs of the shift mechanism are rotated, wherein movement of the shift mechanism moves a plate on which is mounted a gear sector, and wherein the shift mechanism further includes a spur gear which is mounted on a bearing member which surrounds the shift axis shaft and is also part of a hypocycloidal gear arrangement, and wherein the gear assembly further includes a ring gear which is fixed to a mounting assembly, such that when the shift mechanism is in a first position, the gear sector engages the ring gear such that the wheelchair moves in a 1:1 gear ratio, and when the shift mechanism is in its second position, the gear sector is disengaged from the ring gear and the spur gear engages the ring gear, resulting in a movement of the wheel in the second gear ratio by means of the hypocycloidal gear arrangement.

10. The drive mechanism of claim 8, wherein the gear sector, the spur gear and the ring gear all have rounded teeth, to facilitate engagement and disengagement between the ring gear and the spur gear and gear sector, respectively.

11. The drive mechanism of claim 3, wherein the cam element includes a ball plunger member which engages two detent holes in the housing of the gear assembly, wherein engagement of the ball with a hole indicates that the gear assembly is in one of the two gear ratio positions.

12. The drive mechanism of claim 1, wherein the leg members include portions thereof having non-smooth surfaces to facilitate finger contact for the user with the leg members.

13. The drive mechanism of claim 9, wherein the cover plate is such a size and orientation relative to the housing for the gear assembly that the cover plate extends beyond an edge of the housing when the gear assembly is in one gear ratio while when the gear assembly is in the other gear ratio, the plate does not extend beyond the edge of the housing, providing the user an indication of when the shift mechanism is in one position or the other.

14. The drive mechanism of claim 1, wherein the shift mechanism is arranged relative to the gear assembly such that movement of the shift mechanism produces a small movement of the gear assembly in the same direction, which facilitates engagement/disengagement of the spur gear and/or the gear sector relative to the ring gear.

15. The drive mechanism of claim 1, wherein the movement of the shift mechanism is less than 1.5 inches between the two positions.

16. The drive mechanism of claim 1, wherein rotation of an uppermost leg of the shift mechanism forwardly shifts the gear assembly to a lower gear ration than 1:1 and wherein rotation of the uppermost leg of the shift mechanism backwardly shifts the gear assembly back to a 1:1 gear ratio.

17. The drive mechanism of claim 1, including a hub assembly for mounting the wheel to a wheelchair, the hub assembly including means for receiving a screw-in axle, such that axles of various lengths may be easily and conveniently accommodated.

18. The drive mechanism of claim 1, including a hand rim and a plurality of connecting members which removably connect the hand rim to a housing for the gear assembly, providing an easy replacement capability for the hand rim.

19. A wheel for a manual wheelchair, comprising:
a wheel adapted for use with manual wheelchairs, the wheel being solid, with a flat outer region, an intermediate sloping region and a flat central region, with a depth between the outer region and the inner region in the range of ½-2 inches.

20. The wheel of claim 19, wherein the wheel is approximately ¼-inch thick and approximately 1-½ inches in depth between the outer region and the inner region.

21. The wheel of claim 19, wherein the wheel is made from a composite material.

22. The wheel of claim 21, wherein the composite material is carbon fiber with a foam interior.

23. The wheel of claim 19, wherein the outer, intermediate and inner regions are all smooth, continuous and ring-like in configuration.

24. The wheel of claim 19, including a hub assembly for mounting the wheel to a wheelchair, the hub assembly including an inner hub member, an outer hub member and a bearing assembly comprising two adjacent bearings, each bearing having an inner race, an outer race and ball bearings therebetween, the bearing assembly including a shim between either the inner or outer races of the two bearings, the hub assembly further including means for clamping the inner or outer races together with the shim therebetween, and means for clamping the other races together without a shim.

25. The wheel of claim 24, wherein the means for clamping the outer races includes a plurality of fasteners which are spaced around the hub assembly outboard of the bearings, and wherein the means for clamping the inner races together includes a plurality of fasteners positioned inboard of the bearings.

26. The wheel of claim 19, including a hand rim and a plurality of connecting elements which removably connect the hand rim to the wheel, providing a quick replacement capability for the hand rim.

27. The wheel of claim 19, wherein the hand rim is located in the intermediate region of the wheel, providing a narrower wheel assembly while also providing clearance between the hand rim and the wheel for the user's fingers.

28. The wheel of claim 19, including means in the inner hub for receiving a screw-in axle, such that axles of various lengths may be easily and conveniently accommodated.

29. A wheel for a wheelchair, comprising:
a wheel for use with a wheelchair;
a hand rim; and
a plurality of connecting elements removably connecting the hand rim to the wheel, providing an easy replacement capability for the hand rim.

30. A two-speed manual wheelchair, comprising:
a wheelchair wheel;
a gear assembly linked to the wheel which includes a first gear arrangement for driving the wheelchair in a first gear ratio and a second gear arrangement for driving the wheelchair in a second gear ratio;
a shift mechanism mounted for rotation in a plane perpendicular to the wheel axle, to shift the gear mechanism between the first and second gear ratios; and
a hub assembly which connects the wheel to the wheelchair, wherein the hub assembly includes a removable axle which fits into a receiving portion on the wheelchair, such that wheelchairs requiring different lengths of axles can be accommodated using the same wheelchair wheel and different axles.
